(19) United States
(12) Patent Application Publication
(10) Pub. No.: US 2011/0315310 A1
(43) Pub. Date: Dec. 29, 2011

(54) Single press mold process for forming a finished light weight structural component

(75) Inventors: Chris Trevisan, Gregory, MI (US); Randy Foor, Gaines, MI (US); Craig John Longstreet, South Lyon, MI (US); Jason Beauchamp, Fowlerville, MI (US); Scott Scripter, Gowen, MI (US); Sean C. Morrissey, Flint, MI (US); Nathan Dean Swartwood, Perry, MI (US); Joseph Meinke, Gowen, MI (US)

(73) Assignee: Magna International Inc., Aurora (CA)

(21) Appl. No.: 12/803,378

(22) Filed: Jun. 25, 2010

(51) Int. Cl. B29C 70/02

(52) U.S. Cl. 156/245

(57) ABSTRACT

A single process for forming a finished component is described herewith. The process includes providing a core having two outer layers on each side of the core. A water activated resin system is provided that includes a resin and applicator for applying resin to the outer layers at the core. A film layer used for creating a final finished product is placed over the core and resin layers. The layers are pressed to form the finished product.

### FIELD OF THE INVENTION

The present invention relates to a single press mold process for forming finished structural components for automotive applications.

### BACKGROUND OF THE INVENTION

The present invention relates to a single press mold process for forming finished light weight structural components. In particular, the structural components formed are used in automotive applications. Past systems using multiple processed have been developed. For example, U.S. Pat. No. 7,419,713 B2, titled “COMPOSITE COMPONENT”, issued on Sep. 7, 2008 (hereafter referred to as the '713 patent), describes creating composite components having a sandwich structure made of at least one core positioned between two outer layers. The process described by the '713 patent involves the following steps:
(i) Inserting the core and the outer layers into a compression mold, the core being positioned between the outer layers,
(ii) Applying the casting resin system to at least one of the outer layers, steps (i) and (ii) being performed in any order,
(iii) Press molding the core with the outer layers to form the sandwich structure and pressing the outer layers together in at least one area of the sandwich structure.

After the above steps, additional components are applied to the composite component using a second process injection molding. The '713 patent describes two processes that are carried out in separate molds wherein the structural component is formed in the first step using a press mold and then a second step is performed for attaching other structures in order to create the finished component. The present invention improves on the above process by providing a single process wherein a finished component can be created in a single press mold using a single step or process for creating the finished product.

The '713 patent relies on the use of a heat activated resin system having a trade name Baypreg F®, (Bayer A.G., Germany), which requires a high degree heat to be supplied by the press mold in order to form the composite component. In the '713 patent, the heat interferes with the ability to attach other structures. The present invention uses a water catalyst for its resin system, thus allowing for the finished component to be made in a single mold during a single pressing operation. Therefore, the present invention is an improvement over the '713 patent by providing a single step process for creating a finished product which allows for the attachment of a film to the composite component in the press mold, which cannot be accomplished by the process described in the '713 patent due to the amount of heat needed for the resin system disclosed, which can interfere with the ability of the film to attach to the other layers of the structural component.

### SUMMARY OF THE INVENTION

The present invention relates to a single process for forming a finished component. The process includes providing a core having two outer layers on each side of the core. The core material has a honeycomb or corrugated structure creating a partially hollow space within the core. Two outer layers are fibrous material that is connected to the two sides of the core. A water activated resin system is provided that includes a resin and applicator for applying the resin. The process further includes a press mold having a bottom platen and a top platen. Additionally, there is a film layer used for creating a final finished product.

The process includes the step of mixing the water activated resin in the resin system and then applying a first resin layer to the bottom platen of the press mold. The core with outer layers is then inserted into the press mold on top of the first resin layer. A second resin layer is then applied to the top of the core and one of the outer layers followed by the film layer being placed on top of the second resin layer. The final step involves press molding the various layers including the film layer, first and second resin layers, outer layers and core together for a period of time to create a finished structure.

The above process provides a single process for press molding a finished component from a single machine without having to perform subsequent steps for attaching the film layer or other pieces to the core outer layer and resin layers. The process occurs without having to apply a large amount of heat using the press mold. The single process set forth in the present invention provides an improvement over existing methods which require multiple steps or processes for first forming a sandwich structure having the core outer layer and resin layers molded and then subsequently molding the film or attachment pieces on to the structure created in the first step.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1a is a cross-sectional plan view of the finished product created using the single process;

FIG. 1b is an enlarged cross-section view of a portion of the finished product shown in FIG. 1;

FIG. 1c is an exploded perspective view of the layers of the finished structure;

FIG. 2 is an enlarged sectional view of an alternate embodiment of a finished product having two film layers;

FIG. 3 is a plan schematic view showing the process for forming the finished product;

FIG. 4 is a plan schematic view showing the process for forming the finished product;

FIG. 5 is a plan schematic view showing the process for forming the finished product;

FIG. 6 is a plan schematic view showing the process for forming the finished product;

FIG. 7 is a plan schematic view showing the process for forming the finished product;

FIG. 8 is a plan schematic view of an alternate step for the process for forming the finished product; and

FIG. 9 is flow chart of the various steps of the single process for forming the finished components.

### DETAILED DESCRIPTION OF THE PREFERRED EMBODIMENTS

The following description of the preferred embodiment(s) is merely exemplary in nature and is in no way intended to limit the invention, its application, or uses.

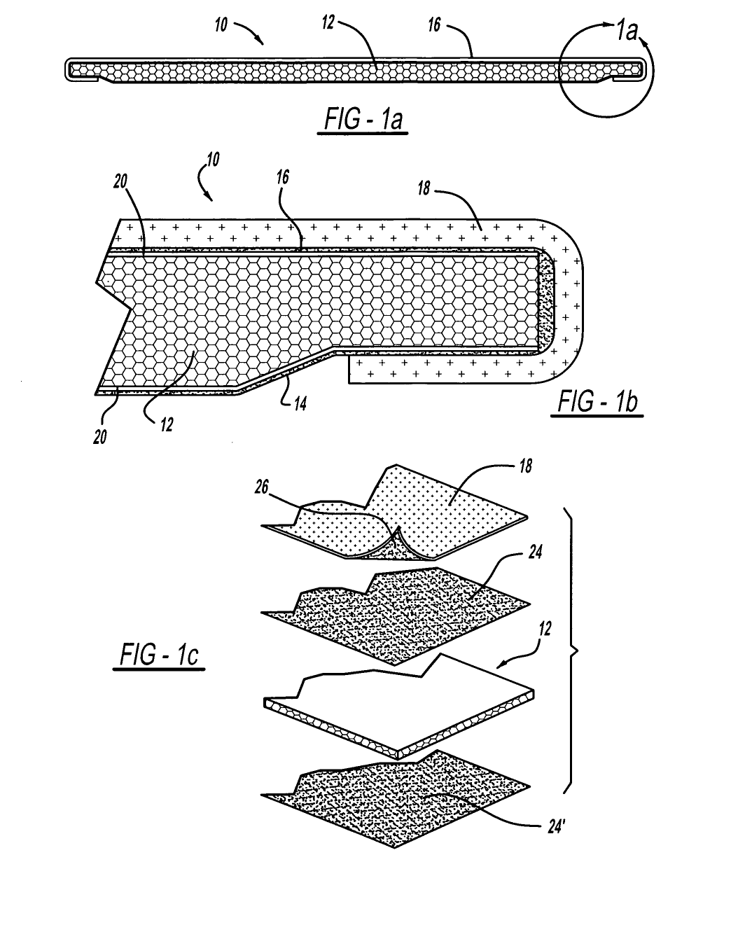

Referring now to FIGS. 1a-1c, various views of the finished structure produced using the single process are shown. The finished structure 10 produced using the single process set forth in the present invention is shown. The finished structure 10 can be virtually any type of structural component for any particular application. Industries where structural components are used include the construction industry such as in the production of wall panels, ceiling tiles, duct work and other HVAC applications. Structural panels are also used in automotive applications for producing interior as well as exterior components. Some automotive applications within the scope of this invention include, but certainly are not limited to spare tire covers, storage covers, battery covers, sun shades, head liners, floor panels and steps. Additionally, structural components for other similar interior components have uses in trucks, busses, aircraft and other vehicles including golf carts. Additionally, light weight structural components for the present application are also useful in electric vehicles, which include covers for the battery systems.

The light weight structural component 10 depicted includes a core 12 which is shown as having a honeycomb shape structure between two backing sheets 20. The core 12 can be made from cardboard, polymer, aluminum, magnesium, polyamides, polyester, polycarbonates, polypropylenes, polystyrenes, wood, flax, sisal, jute, hemp or combinations thereof. Additionally, the honeycomb structure can be replaced with other suitable shapes such as diamonds, corrugated fiber board or other structures that create open space between the backing sheets 20. Connected to the backing sheets 20 is a top and bottom outer layer 24, 24′. When the top and bottom outer layers 24, 24′ are connected to the backing layers 20 to form the finished product, the outer layers are combined with resin to form bottom resin outer layer 14 and top resin outer layer 16 of the finished product 10 is shown in FIGS. 1a-1b.

Prior to the single press mold process set forth in this invention, the top and bottom outer layers 24, 24′ are connected to the backing layers 20 of the core 22 by way of adhesive or some other suitable mechanical connection. However, the connection is optional and it is within the scope of the invention to keep the layers separate. The finished product 10 further includes a film layer 18 having a connection surface 26 configured to be adjacent to the top outer layer 24 of the core 12. When resin is introduced to the top outer layer 20, the connection backing 26 adheres to the top resin outer layer 16 when the finished product 10 is formed. The film layer 18 can include any type of material suitable for creating a desired finished product. The film layer 18 can include carpet, vinyl, leather, polyurethane, glass, polymers, fabric, as well as structures for attachment such as hooks, fasteners, etc. . . . The finished structure 10 created using the single process set forth in the invention includes the layers shown in the sandwich structure depicted in FIG. 1b formed together after the single process is carried out.

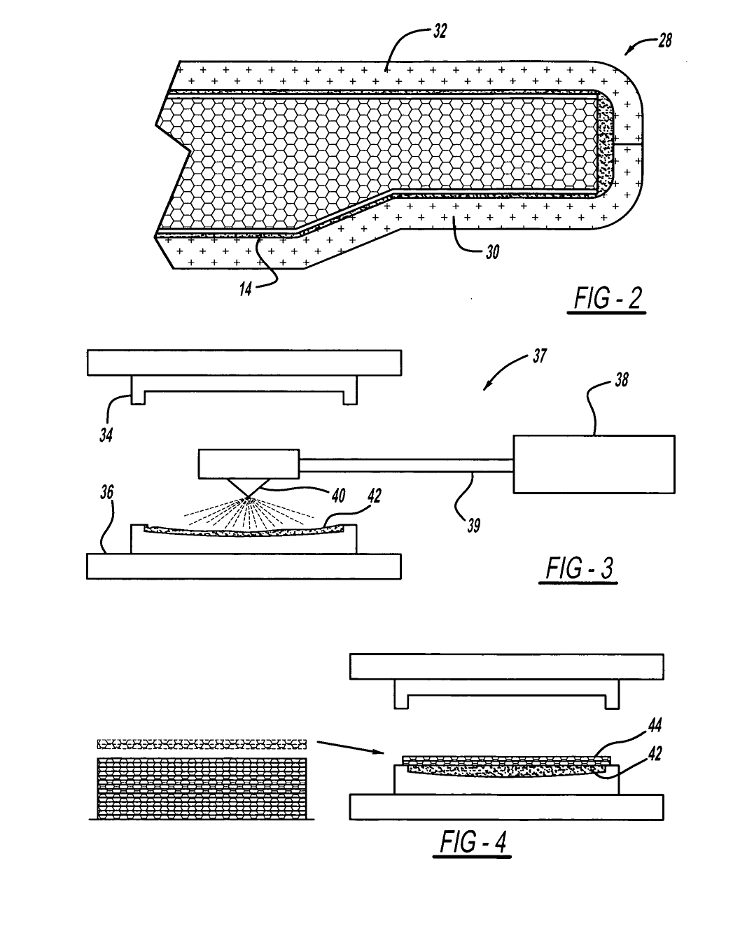

FIG. 2 depicts an alternate embodiment showing an alternate finished structure 28. The alternate finished structure 28 is similar to the finished structure 10 depicted in 1a-1c with the exception of there being an optional bottom film layer 30 connected to the bottom resin outer layer 14 of the finished structure 28. This optional bottom film layer 30 is in addition to a top film layer 32, which is similar in structure to the film layer 18 shown in FIG. 1b. This particular alternate is suitable for applications where both sides of the structural component need to have a finished surface. An example of a structure where both sides need a finished surface is a sun visor.

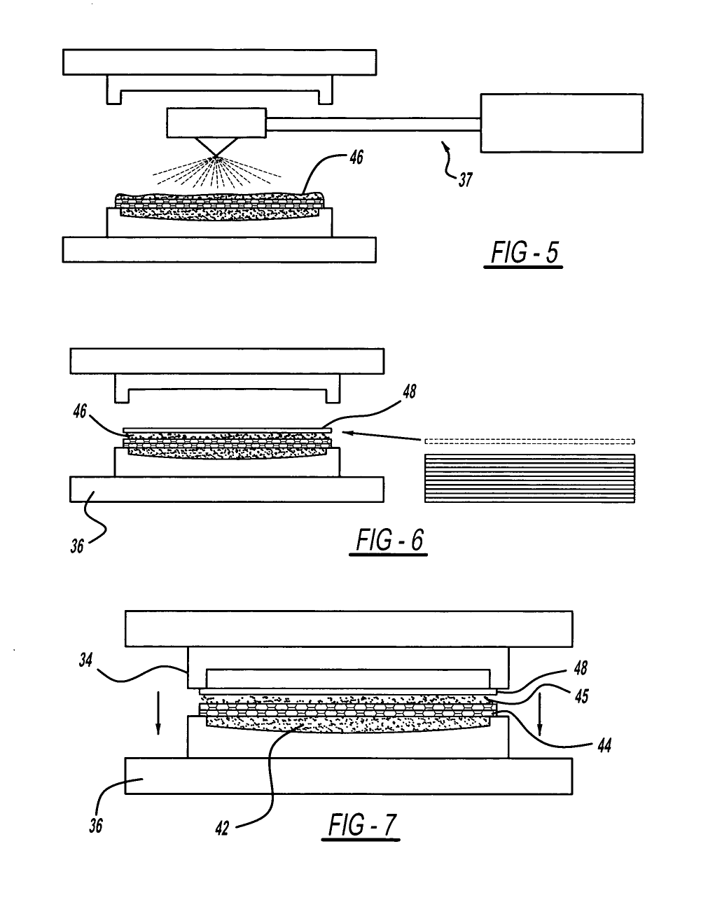

Referring now to FIGS. 3-7, schematic representations showing the steps of the single process for creating the structural component are shown. The term single process as used throughout this application is not referring to the number of steps involved, but rather is referring to the fact that the finished products 10, 28 are created from a single press mold structure without the need for further processes to attach film layers or other components to the core structure.

Referring now to FIG. 3, a press mold having a top platen 34 and bottom platen 36 are shown. A resin mixing system 37 having a housing 38 for mixing resin and pumping it through a robotic arm 39 to an applicator 40 is shown. The resin is sprayed out of the applicator 40 onto the bottom platen 36 creating a first resin layer 42. The resin mixed within the housing 38 of the resin system 37 is a two component polyurethane resin material that uses water as a catalyst. After the water and resin are mixed together a chemical reaction immediately begins and the mixed resin is quickly pumped through the robotic arm 39 to the applicator 40.

The resin used in the resin system for creating the first and second resin layers is a water activated polyurethane consisting of a polyol and isocyanate. More specific applications include one of or a combination of chemical compounds including polymeric diphenylmethane diisocyanate, polyether polyol, polyethylene glycol, polyisocyanate, polyaddition, polyol, triethanolamine, ethylene glycol. The resin system generally uses water as a catalyst. However, it is within the scope of this invention for the catalyst to be any type of compound containing active hydrogens. These include, but are not limited to water, alcohol, amines, bases and acids, and combinations thereof. Additional catalysts include oxidizing agents and alkalis. It is within the scope of this invention for related compounds to be used for forming the resin as well as related or functionally equivalent catalysts.

After the step of spraying the first resin layer 42 onto the lower platen 36, a structural core 44, which is the core layer 12 and top and bottom outer layers 24, 24′ layered together, is placed over the first resin layer 42 on the bottom platen 36. In the next step, a second resin layer is sprayed onto the top side of the structural core 44 using the resin system 37. Then a film layer 48 is placed in the bottom platen 36 over the second resin layer 46. In a final step, the upper platen 34 is closed downward against the bottom platen 36 in order to perform a press operation wherein the bottom resin layer 42, the structural core 44, top resin layer 46 and film layer 48 are pressed together in order to form the finished structure 10 depicted in FIGS. 1a-1c.

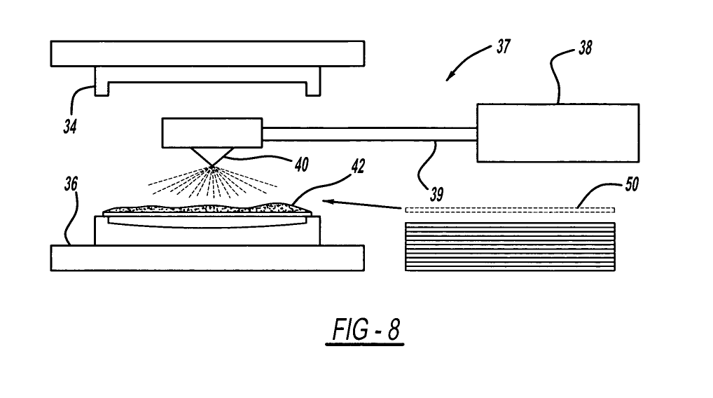

In an alternate aspect of the invention, shown in FIG. 8, a bottom film layer 50 is placed into the bottom platen 36 of the press mold prior to applying the first resin layer 42. This optional step is used to create the finished structure 28 shown in FIG. 2. The rest of the steps in the process are carried out as shown in FIGS. 3-7 with the only difference being that there is bottom film layer 50 in the platen prior to spraying the first film layer 42 into the bottom platen 36.

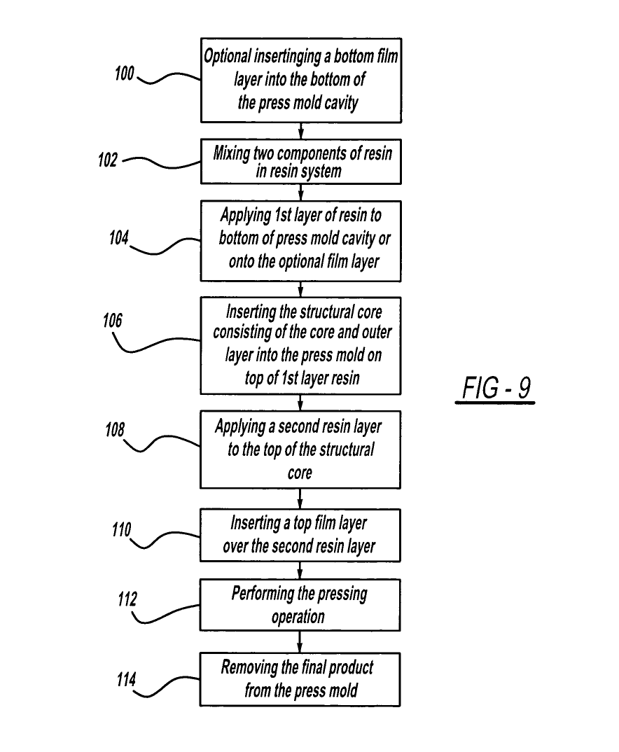

FIG. 9 depicts a flow chart showing the steps of the single process. At step 100, the optional inserting of a bottom film layer into the bottom platen of the press mold is carried out. As stated above, this step is optional and only occurs in applications where it is desired to have a bottom film layer. At step 102 the resin system 37 begins mixing the two components of the resin in the resin system. This is carried out in the housing 38 shown in FIG. 3. At step 104, a first layer of resin is applied to the bottom press mold platen. In the optional embodiment of the invention, the first layer of resin is applied to the optional film layer set out in step 100. At step 106, the structural core consisting of the core and outer layers is inserted into the bottom platen of the press mold on top of the first layer of resin. At step 108, a second resin layer is applied to the top of the structural core. At a step 110, a top film layer is placed over the second resin layer. At a step 112, performing the pressing operation is carried out wherein the top platen 34 is moved downward against the bottom platen 36. The pressing operation involves the top platen 34 applying pressure in the direction of the bottom platen 36 in order to provide time for the first resin layer and the second resin layer to bond with the various components and cure to form the finished structure. The pressing operation takes approximately one hundred twenty seconds; however a greater or lesser amount of time can be needed depending upon the finished structure being created and the thickness of the various layers of the finished structure. The process depicted in FIG. 9 creates a finished structure is created in the absence of any heat generated by the press mold. In other words, the top platen 34 and bottom platen 36 do not provide any heat for the process to be carried out.

With regard to the size of the various layers, it is within the scope of this invention for layers to have virtually any type of thickness depending on the type of structure being created. However, for creating interior structural components for an automobile, the present invention contemplates that the core has a thickness that is selected from a range of about 5 mm to about 30 mm. The outer layers that are connected to the core have a density that is one selected from the range of about 150 g/m² to about 1500 g/m². The film layer placed over the top of the core in the outer layers has a thickness of about 3 mm. The finished structure has an overall thickness of about 20 mm.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A single process for forming a finished component comprising the steps of:
providing a core having two outer layers on each side of the core, a water activated resin system, resin, a press mold having a bottom platen, a top platen, and a film layer;
mixing the water activated resin in the resin system;
applying a first resin layer to the bottom platen of the press mold;
inserting the core and outer layers into the press mold on top of the first resin layer;
applying a second resin layer to the top of the core and outer layers;
inserting into the bottom platen of the press mold the film layer on top of the second resin layer; and
press molding the film layer, first and second resin layers, outer layers and core together to create a finished structure.

2. The process of claim 1 wherein said step of press molding the finished structure is performed in the absence of heat generated by the press mold.

3. The process of claim 1 wherein the resin is a water activated polyurethane resin.

4. The process of claim 1 wherein the outer layers are one selected from the group comprising fiberglass, fiber mats, meshes, woven fabrics, knitted fabrics, braided fabrics, nonwoven fabrics or felts, aluminum, magnesium, plastics, polyamides, polyesters, polycarbonates, polypropylenes, polystyrenes, flax, sisal and hemp, and combinations thereof.

5. The process of claim 1 wherein the core is one selected from the group comprising paper core material, polymer, cardboard, aluminum, magnesium, polyamides, polyesters, polycarbonates, polypropylenes, polystyrenes, wood, flax, sisal, jute, hemp, and combinations thereof.

6. The processing film of claim 1 wherein the core has a honeycomb structure.

7. The process of claim 1 wherein the core is one thickness selected from a range of about 5 mm to about 30 mm.

8. The process of claim 1 wherein the outer layer has a density that is one selected from the range comprising about 150 g/M² to about 1500 g/M² per side of said core.

9. The process of claim 1 wherein said finished product is one selected from the group comprising:
spare tire covers, storage covers, battery covers, sun shade, head liners, steps and floor panels.

10. The process of claim 1 wherein the film layer is one selected from the group comprising carpet, vinyl, leather, polyurethane, glass, polymers, fabric, and combinations thereof.

11. The process of claim 1 wherein the first and second resin layers are one selected from the group comprising polymeric diphenylmethane diisocyanate, polyether polyol, polyethylene glycol, polyisocyanate, polyaddition polyol, triethanolamine, ethylene glycol and combinations thereof.

12. The process of claim 11 wherein the first and second resin systems uses one of the following catalysts: oxidizing agents, alkalis, materials containing active hydrogens, water, alcohol, amines, bases and acids, and combinations thereof.

13. A single process for forming a finished component comprising the steps of:
providing a core having two outer layers on each side of the core, a water activated resin system, resin system, a press mold having a bottom platen and a top platen, a first film layer and a second film layer;
inserting the first film layer into the bottom platen of the press mold;
mixing the water activated resin in the resin system;
applying a first resin layer to the bottom platen of the press mold using the resin system;
inserting the core and outer layers into the press mold on top of the first resin layer;
applying a second resin layer to the top of the core and outer layers;
inserting into the bottom platen of the press mold the film layer on top of the second resin layer; and
press molding the first and second film layers, first and second resin layers, outer layers and core together to create a finished structure.

14. The process of claim 11 wherein said step of press molding the finished structure is performed in the absence of heat generated by the press mold.

15. The process of claim 11 wherein the resin is a water activated polyurethane resin.

16. The process of claim 11 wherein the outer layers are one selected from the group comprising fiberglass, fiber mats, meshes, woven fabrics, knitted fabrics, braided fabrics, nonwoven fabrics or felts, aluminum, magnesium, plastics, polyamides, polyesters, polycarbonates, polypropylenes, polystyrenes, flax, sisal and hemp, and combinations thereof.

17. The process of claim 11 wherein the core is one selected from the group comprising paper core material, polymer, cardboard, aluminum, magnesium, polyamides, polyesters, polycarbonates, polypropylenes, polystyrenes, wood, flax, sisal, jute, hemp, and combinations thereof.

18. The processing film of claim 11 wherein the core has a honeycomb structure.

19. The process of claim 11 wherein the core is one thickness selected from a range of about 5 mm to about 30 mm.

20. The process of claim 11 wherein the outer layer has a density that is one selected from the range comprising about 150 g/M² to about 1500 g/M² per side of said core.

21. The process of claim 11 wherein said finished product is one selected from the group comprising:
spare tire covers, storage covers, battery covers, sun shade, head liners, steps and floor panels.

22. The process of claim 13 wherein the film layer is one selected from the group comprising carpet, vinyl, leather, polyurethane, glass, polymers, fabric, and combinations thereof.

23. The process of claim 13 wherein the first and second resin layers are one selected from the group comprising polymeric diphenylmethane diisocyanate, polyether polyol, polyethylene glycol, polyisocyanate, polyaddition polyol, triethanolamine, ethylene glycol and combinations thereof.

24. The process of claim 23 wherein the first and second resin systems uses one of the following catalysts: oxidizing agents, alkalis, materials containing active hydrogens, water, alcohol, amines, bases and acids, and combinations thereof.
